(19) United States
(12) Patent Application Publication
(10) Pub. No.: US 2010/0100405 A1
(43) Pub. Date: Apr. 22, 2010

(54) Method and Apparatus for Determining and Managing Sustainability Ratings

(75) Inventors: Gerard Lepore, Mt. Pleasant, SC (US); Adam Bernholz, Sullivan Island, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Green Wizard, LLC

(21) Appl. No.: 12/580,634

(22) Filed: Oct. 16, 2009

Related U.S. Application Data
(60) Provisional application No. 61/106,433, filed on Oct. 17, 2008.

(51) Int. Cl. G06Q 10/00; G06N 5/02; G06Q 30/00

(52) U.S. Cl. 705/7; 706/47; 705/26

(57) ABSTRACT

Methods and apparatuses for determining and managing sustainability ratings are provided. An example method may include receiving a construction product type and identifying a first candidate construction product within a database based at least in part on the construction product type. The first candidate construction product may be associated with sustainability data for the first candidate construction product. The example method may also include determining a first sustainability rating based at least in part on the sustainability data for the first candidate construction product through application of sustainability rules. Other methods and apparatuses are also provided.

### CROSS-REFERENCE TO RELATED APPLICATIONS

The present application claims priority to U.S. Provisional Application No. 61/106,433 filed Oct. 17, 2008, the contents of which are incorporated by reference herein in their entirety.

### TECHNOLOGICAL FIELD

Embodiments of the present invention relate generally to construction product selection. More particularly, embodiments of the present invention relate to determining and managing sustainability ratings for construction products.

### BACKGROUND

High-performance buildings, whether certified by Leadership in Energy and Environmental Design (LEED®), Energy Star, or others, require the evaluation of very specific building materials with a number of new and unique attributes. In turn, this building movement has caused a profound change in the way building products are researched, analyzed, and documented. Additionally, designing high-performance buildings has forced a fundamental change in workflow and decision-making processes with respect to constructing high-performance buildings.

Historically, building products were commodity products typically purchased by a contractor based solely upon price. Today's world of sustainable and high-performance building products necessarily contain a myriad of relevant attributes, ranging from R and U values associated with energy efficiency, to location of manufacturer, extraction location of raw materials, recycled content, bio-based content, forestry certification, etc., each associated with sustainable attributes. High-performance building products have very specific parameters for health attributes ranging from volatile organic compound (VOC) levels to urea-formaldehyde content. To compound the problem, the historical knowledge of materials and their characteristics typically found by contractors is of little benefit since the responsibility for evaluating materials has now become the burden of the architects and engineers. Materials decisions can be highly project-specific, and the information cannot readily be translated into the collective wisdom of future projects.

### BRIEF SUMMARY OF SOME EXAMPLES OF THE INVENTION

Example embodiments of the present invention described herein provide for determining and managing sustainability ratings to facilitate the selection of construction products when preparing for construction of, for example, a building. In this regard, some example embodiments may receive inputs, such as construction project parameters, in the form of a construction product type or requirement. Based on at least the construction product type, a candidate construction product may be identified. A database of sustainability information associated with a number of construction products may be queried to identify the candidate construction product(s). Using sustainability data associated with the candidate construction product, a sustainability rating may be determined through application of sustainability rules on sustainability data associated with the candidate construction product. According to various example embodiments, the sustainability rules may be defined in accordance with the sustainability standards of, for example, governmental entities. According to some example embodiments, sustainability rating for various construction product selections may be aggregated to determine a total project sustainability rating. Example embodiments of the present invention also provide for researching, evaluating, specifying, bidding, purchasing, and documenting appropriate construction products for use in a construction project, based at least in part on sustainability data associated with the construction products.

According to one example embodiment, an example method is provided. The example method may include receiving a construction product type and identifying at least a first candidate construction product within a database based at least in part on the construction product type. The first candidate construction product may be associated with sustainability data for the first candidate construction product. The example method may also include determining a first sustainability rating based at least in part on the sustainability data for the first candidate construction product through application of sustainability rules.

Another example embodiment of the present invention is a computer-readable storage medium having executable computer-readable program code instructions stored therein. The computer-readable program code instructions may be configured to cause an apparatus to perform various functionalities. In this regard, the instructions may be configured to cause the apparatus to perform receiving a construction product type, and identifying a first candidate construction product within a database based at least in part on the construction product type. The first candidate construction product may be associated with sustainability data for the first candidate construction product. The instructions may be further configured to cause the apparatus to perform determining a first sustainability rating based at least in part on the sustainability data for the first candidate construction product through application of sustainability rules.

Yet another example embodiment of the present invention is a computer-readable storage medium having executable computer-readable program code instructions stored therein. The computer-readable program code instructions may be configured to cause an apparatus to perform various functionalities. The instructions may be configured to cause the apparatus to perform receiving a construction product type from an application being executed by the apparatus. The instructions may also be configured to cause the apparatus to perform providing the construction product type to a network entity and retrieving first candidate construction product information from the network entity. Further, the instructions may also be configured to cause the apparatus to perform providing a first sustainability rating, the first sustainability rating being determined through application of sustainability data for the first candidate construction product and the sustainability rules.

The above summary is provided merely for purposes of summarizing some example embodiments of the invention to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those summarized.

### BRIEF DESCRIPTION OF THE DRAWINGS

Having thus described embodiments of the invention in general terms, reference will now be made to the accompanying drawings, which are not necessarily drawn to scale, and wherein:

FIGS. 1a-1c illustrate block diagrams for researching, evaluating, specifying, bidding, purchasing, and documenting a construction project in accordance with various example embodiments of the present invention;

FIG. 2 illustrates a block diagram describing the operation of a sustainability rating engine in accordance with various example embodiments of the present invention;

FIGS. 3a-3c illustrate example sustainability output information as generated by a sustainability rating engine in accordance with various example embodiments of the present invention;

FIG. 4a illustrates a block diagram of a system including a server implementing a sustainability rating engine in accordance with various example embodiments of the present invention;

FIG. 4b illustrates a block diagram of a system including a communications terminal implementing a sustainability rating engine in accordance with various example embodiments of the present invention; and

FIGS. 5a-5c and 6 illustrate example methods for determining and managing sustainability ratings in accordance with various example embodiments of the present invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

Various example embodiments of the present invention provide for determining and managing sustainability ratings for construction products to assist engineers, architects, project designers, project managers, business owners, and the like in selecting and purchasing construction products that satisfy the environmental, energy, health, and efficiency needs for a construction project. As used herein, the term sustainability may refer to the ability to acquire, manufacture, and utilize a construction product such that resultant effects on the raw material supply and the environment may be decreased through natural processes or through human intervention. For example, the utilization of pine lumber for construction may be sustainable as a result of the ability to replant and grow pine trees. Sustainability data associated with a given construction product may broadly describe the attributes of the construction product that implicate sustainability considerations including the product's impacts on energy and water use and efficiency, the environment, health, raw material extraction locations, manufacturing locations, raw material certifications (e.g., certified forestry programs), amount of recycled content, amount of reused content, amount of renewable material, emissive qualities, and the like.

Through the use of construction product sustainability data, example embodiments may be configured to support researching, evaluating, specifying, bidding, purchasing, and documenting appropriate construction products or materials for a particular green or sustainable building project. User-defined subjective and objective criteria may be matched against a database of construction products, product information, and industry practices to recommend general building guidelines, product types, and product class performance specifications based upon, for example, industry practices combined with the specific subjective and objective project data. Specific products and the products' manufacturers may be presented based on the sustainability data of the construction products combined with information entered, for example, by the user. As such, individual construction products, or a mix of construction products for a given construction project, may be analyzed with respect to sustainability rules, for example, defined by government or regulatory organizations, to determine a sustainability rating to assist a user in the selection of construction products appropriate for a given project. The sustainability rating may take a number of forms such as a score, a level (e.g., a certification level), or the like. Sustainability rules may be rules defined in accordance with, for example, the Leadership in Energy and Environmental Design (LEED®) green building rating system developed by the United States Green Building Council (USGBC), the National Association of Home Builders (NAHB), the Green Building Initiative (GBI™), Energy Star, or the like. The rating system for LEED projects may be determined via the rules for determining ratings as provided in Green Building Design and Construction Reference Guide, 2009 Edition; Green Interior Design and Construction Reference Guide, 2009 Edition; and Green Building Operations and Maintenance Reference Guide, 2009 Edition; all of which are incorporated by reference herein in their entirety.

In particular, with respect to LEED certification, example embodiments of the present invention may be configured to determine a sustainability rating in the form of a number of LEED credits associated with the use of a particular product in a construction project. Since LEED certification also incorporates levels of certification (e.g., certified, silver, gold, and platinum), according to some example embodiments, determination of the sustainability rating may refer to the level of certification under LEED.

The sustainability rating may be compared and analyzed with respect to other factors, such as price, to optimize the sustainability rating given a particular budget for a construction project. In this regard, a least expensive collection of construction products may be presented that satisfy sustainability criteria for a given construction project. In a similar manner, given a project budget, a maximum sustainability rating may be achieved by presenting the appropriate products for maximizing the sustainability rating, while remaining within the constraints of the project budget.

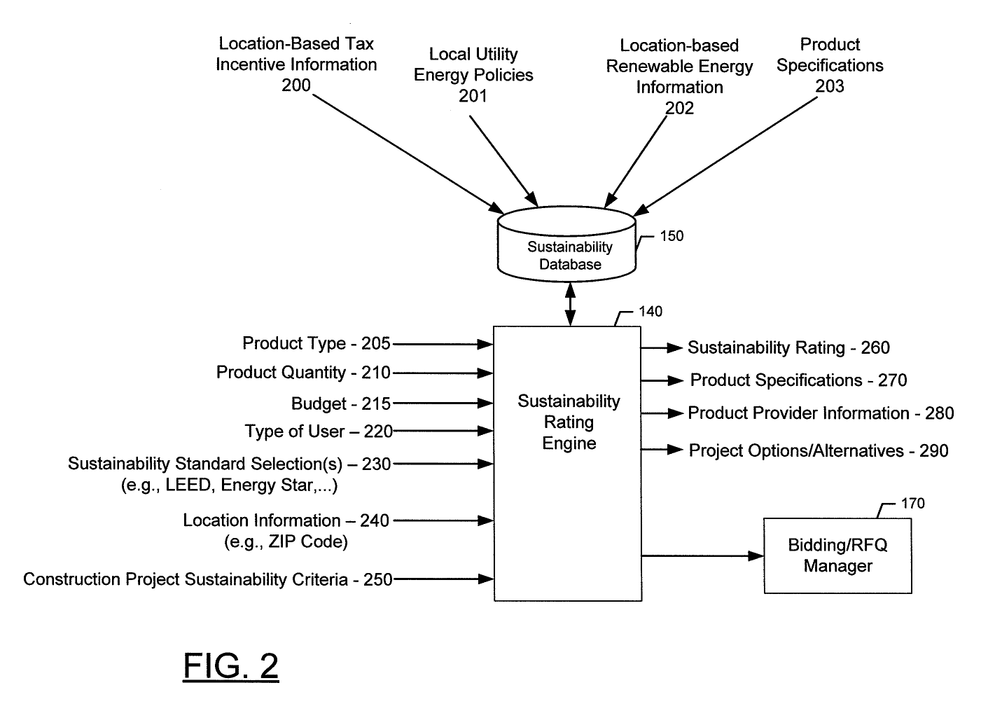

According to various example embodiments of the present invention, to facilitate determining a sustainability rating, and the performance of the other functionality described herein, a sustainability database may be implemented. The sustainability database may include various types of information that may be queried and analyzed based on various criteria including, for example, sustainability criteria. In this regard, and as further described below with respect to FIG. 2, the sustainability database may include location-based tax incentive information, local utility energy policies, location-based renewable energy information, construction product specifications and attributes, and the like. Based on the information stored in the sustainability database, sustainability rules may be applied to criteria provided, for example, by a user for a construction project, and a sustainability rating may be generated, as well as other functionality described herein.

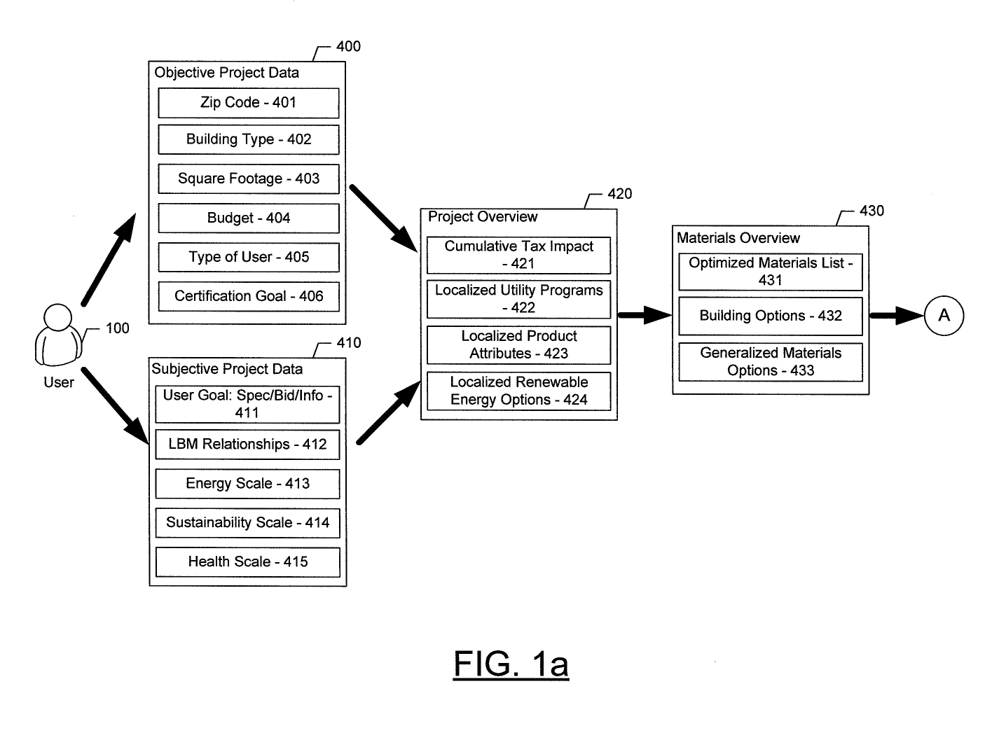

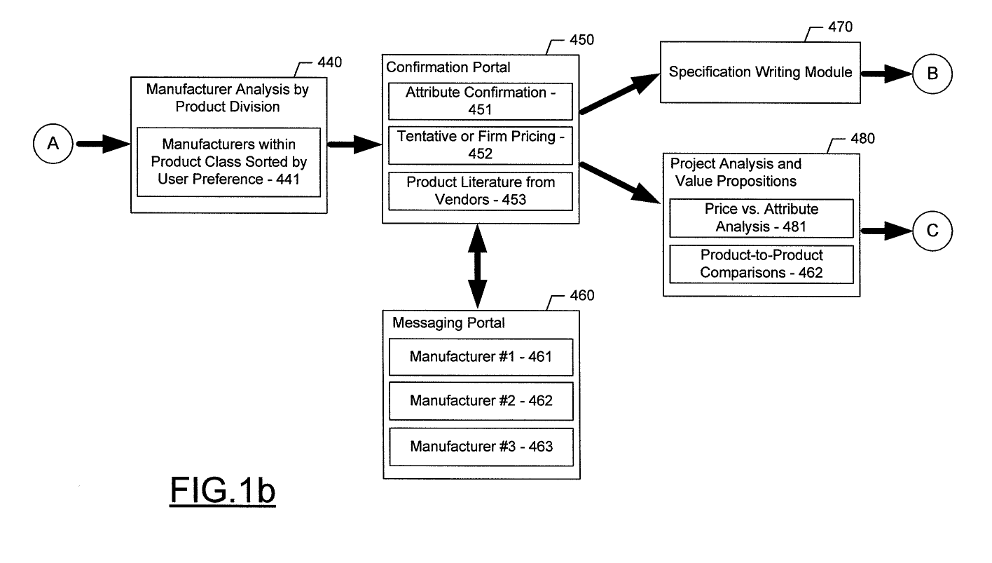

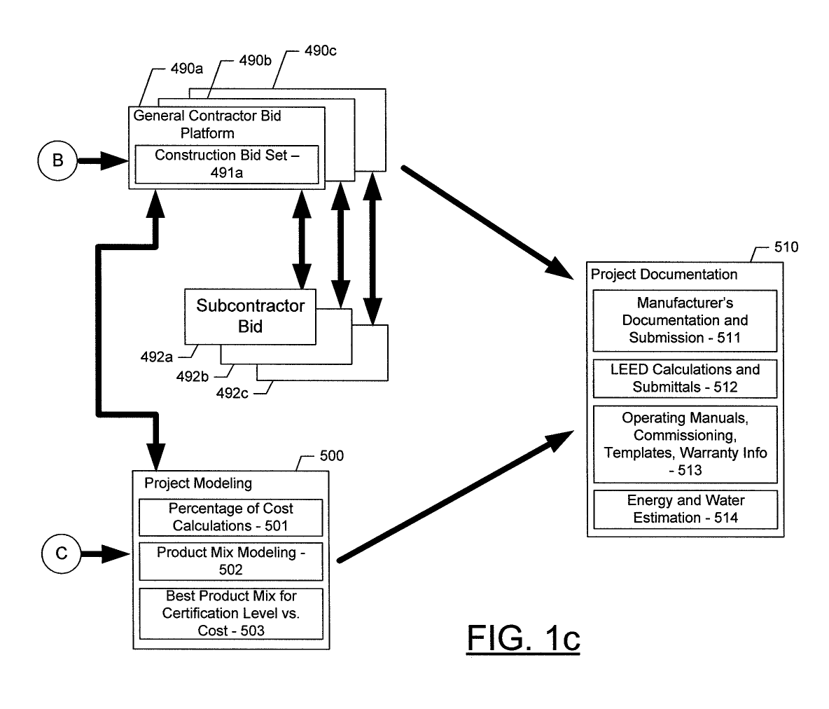

With respect to the aforementioned functionality, FIGS. 1a through 1c illustrate an example method and associated system according to some example embodiments of the present invention. To begin, the example method may receive inputs in the form of objective project data 400 and subjective project data 410. With respect to the objective project data 400, a number of parameters may be provided including, but not limited to, a zip code 401, a building type 402, square footage 403, a budget 404, a type of user 405, and a certification goal 406. According to various example embodiments, the zip code 401 may be an example of a type of location information that may be provided to describe the location of the construction project. The building type 402 (e.g., type of construction) and the type of user 405 may be used to indicate whether the building to be constructed will be used for commercial or government (e.g., federal or state/local) use. The square footage 403 may indicate the size of the building, and the budget 404 may be an indication of the amount of money allotted for the project or the amount of money allotted for particular aspects of a project. The certification goal 406 may be a form of sustainability criteria for the project indicating a desired total project sustainability rating, which in accordance with some example embodiments, may be an aggregate of the sustainability rating for a number of construction products to be used for the project.

With respect to the subjective project data 410, a number of parameters may be provided including, but not limited to, a user goal 411, lumber and building materials (LBM) relationships 412, an energy scale 413, a sustainability scale 414, and a health scale 415. The user goal 411 may be an indication of the user's desired results for implementing the example method. For example, the user may wish to generate a construction product specification, make a bid for construction product, or obtain information about a construction product. The lumber and building material relationships 412 may be an indication of the user's relationships within the construction market. The energy scale 413, the sustainability scale 414, and the health scale 415 may be indications of a user's needs or desires for the construction project in these areas. According to some example embodiments, the user may provide a score on a scale of one to ten for each of the energy scale 413, the sustainability scale 414, and the health scale 415.

The entry and utilization of the objective and subjective project data may be configured to form a research portion of the example method. In this regard, the objective product data 400, including the zip code 401, the building type 402, the square footage 403, and the budget 404 may be utilized to query a sustainability database to determine a cumulative tax impact 421 for the construction project as part of the project overview 420. Additionally, the zip code 401 may be utilized to determine, via the sustainability database the localized utility programs 422. In this regard, programs for energy purchasing and energy sales may be determined for the utility that provides service to the geographic area associated with the zip code 401. Further, the objective project data 410 including the zip code 401, the building type 402, the square footage 403, and the budget 404 may be utilized to query the sustainability database to determine localized product attributes 423. Localized product attributes may be information regarding the types of construction products that would be suitable for use in the geographic area defined by the zip code 401. The objective project data including the zip code 401, the building type 402, the square footage 403, the budget 404, and the certification goal 406 may used to query the sustainability database to determine the localized renewable energy options 424 within the project overview 420. The localized renewable energy options 424 may indicate the types of renewable energy that may be suitable for the particular climate located in the geographic are defined by the zip code 401.

Based on the information gathered for the project overview 420, a material overview 430 may be determined. According to various example embodiments, the materials overview 430 may be obtained by analyzing objective project data 400 with the subjective project data 410 in conjunction with the information of the project overview 420. The subjective project data 410, and more particularly, the energy scale 413, the sustainability scale 414, and the health scale 415 may be analyzed with objective project data 400, and filtered through the information of the project overview 420 to determine an optimized material list 431, building options 432, and generalized materials options 433. The optimized materials list 431, the building options 432, and the generalized materials options 433 may collectively identify a number of construction products that may be suitable for the construction project.

The example method may continue with FIG. 1b, where additional analysis of the project may be performed. In this regard, the materials overview 430 may be broken down and sorted by manufacturers within each product class (or product type), to generate information for manufacturer analysis by product division 440, which include construction products for use in the project. The manufacturers may be broken down further within each product class by the user's objective project data 400 and subjective project data 410. In this manner, based on the user's preferences, the manufacturers may be sorted by product class at 441. If the user agrees to the construction product selections presented in the manufacturer analysis by product division 440, the selections may be presented to the confirmation portal 450. Within the confirmation portal 450, depending on the user's desires as indicated by the user goal 411, product literature from vendor 453 may be provided, for example, from the sustainability database or requested from the provider. Additionally, or alternatively, the messaging portal 460, may be configured to send information requests to the appropriate manufacturers (e.g., manufacturer #1 461, manufacturer #2 462, manufacturer #3 463) and/or their suppliers regarding the selected construction products. Depending on the reply from the manufacturers or suppliers, the messaging portal 460 may direct the confirmation portal 450 to generate a construction product attribute confirmation 451 and/or information regarding tentative or firm pricing 452. Further, according to some example embodiments, the messaging portal 460, as well as other features, may be omitted and pricing information may be made available via the sustainability database or through another interface to construction product providers. Additionally, in accordance with some example embodiments, attribute confirmation 451 may be omitted and, for example, specification writing may be performed without having confirmed the attributes of a product with a manufacturer.

Based on the user goal 411, the responses from manufacturers may be analyzed with respect to attribute confirmation 451, and a blended specification may be prepared that includes the sustainable attributes of some or all of the selected products. The analytical and specification writing portion of the example method may be performed via the specification writing module 470.

Alternatively, if the user goal 411 is to receive tentative or firm pricing from the manufacturers and/or suppliers at 452, the pricing provided via the messaging portal 460 may become the basis for project analysis and value propositions 480. Within the project analysis and value propositions 480, the attributes of the products, such as the inherent attributes, may be compared and contrasted against associated price points, thereby providing the user with the ability to perform a relative green value proposition analysis of any one product versus the product's peers.

FIG. 1c illustrates additional aspects of the example method that may involve modeling, purchasing, and documentation of the selected construction products within project modeling 500, the general contractor bid platforms 490a, 490b, and 490c, and project documentation 510. With respect to project modeling 500, the user may be presented an overview of the project, for example, illustrating each of the major product classes and the mix of manufacturers within each product class. Using percentage of cost calculations 501, a construction project may be modeled according to, for example, a LEED analysis, by which the cost of each product and the product's attributes may be analyzed in terms of the cost of an associated collection of construction product for the project. Based on the selected manufacturers within each product class, an analysis may be performed to display the cost of the total collection of products and the associated percentages, as a percentage cost of the entire project. The collection of goods may be analyzed with respect to, for example, the currently-accepted six principal sustainable criteria of regionally manufactured, recycled content, reused content, renewable content, low emissive content, and certified wood content.

Within project modeling 500, depending upon the type of certification sought, rules may be used to evaluate the appropriate amount of regional materials given the project's location and the points of extraction and manufacturer for the product to be used in the project. Similarly, depending upon the certification authority, the appropriate percentage of recycled content may be analyzed as promulgated by the rules of the given certification authority. Based on the particular certifying authority, and the rules defined by the certifying authority, additional or alternative objective or subjective project data may be required. In product mix modeling 502, the user may select various alternative manufacturers, within any or all product classes, and determine the relative impact on both the project cost, and the relative effect on the percentage of cost calculations, for example, for the six major sustainable attribute categories. In the best product mix for certification level versus cost 503, an analysis may be performed to determine the best mix of products, based on the product's sustainable attributes. The analysis may include the best mix of products at the lowest price point to achieve a targeted sustainability rating (e.g., points or certification level), or, alternatively, the highest sustainability rating available based on a predetermined maximum price for the collection of goods.

The general contractor bid platforms 490 may allow a user, such as an architect or project manager to upload a copy of the project's plan sets and specifications to a server. The project plan sets and specifications may be housed in the construction bid set 491a. As such, the user may be able to allow selected contractors, as indicated at 490a, 490b, and 490c, to review the project plan sets and specifications, and make a bid for the construction of the project or for a particular aspect of the project. Restrictions may be implemented to limit access to the construction bid sets. In addition, by having the bulk of the project costs inherent in the bid set, a contractor may prepare a bid more rapidly, as well as determine alternate substitutions for any one of the specified construction products. The contractor may be able to re-bid any or all of the products included in the project plan sets and specifications. If a contractor has trade relationships with local vendors/suppliers of the products, the contractor may re-price bids given the associated incentives (e.g., tax incentives). The general contractor bids platform 490, therefore, allows a user to reach multiple vendors/suppliers at the point in the supply chain that is appropriate information for the manufacturers, and allows a user to enter the appropriate a single time and shop multiple sources of sustainable building products. In this manner, for example, quotes may be received from numerous vendors/suppliers without the involvement of a middle entity or other changes to the supply chain.

With respect to the general contractor bid platform 490, the contractor may assign portions of the construction bid set 491a to subcontractors for bidding in the subcontractor bid 492. As such, a contractor may invite a number of subcontractors, as indicated by 492a, 492b, and 492c to bid on the products or work as described in the construction bid set 491a. As with the general contractor bid platform, the subcontractors may review the product manufacturers chosen in the original specifications, or choose alternatives for analysis and bidding. Also, as within the general contractor bid platform, the sub-contractor may re-bid any of the earlier pricing to receive firm pricing and/or take advantage of any trade discounts that may be available.

Project documentation 510 allows the user to document the sustainable attributes for the products and materials purchased for the project, including the cost, and submit the documents to the relevant certifying organization. Within the manufacturer's documentation and submission 511, the sustainable attributes as provided by the manufacturer associated with each product may be documented. When final purchasing decisions are confirmed, a letter/document from each manufacturer may be prepared stating, for example, where the product was extracted/manufactured, the product's recycled, renewable, reused, emissive, and certified wood qualities, in addition to any other performance attributes.

In LEED calculations and submittals 512, relevant portions of the LEED online portal, or another type of certification entity portal, may be populated for the project. For example, relevant sections of the LEED online portal associated with products cost and the range of sustainable attributes may be populated with supporting documentation. Additionally, in operating manuals, commissioning templates, and warranty information 513, reports may be prepared for some or all of the relevant products and materials included in the project. The reports may include operating manuals and warranty information for some or all materials or products purchased. In addition, commissioning reports may be prepared for some or all of the materials or products included in the project. In energy and water estimation 514, estimates of the amount of water and energy used in the project may be determined and correlated against baseline estimated levels for a similar building.

Having described the various aspects of the example method of FIGS. 1a through 1c, the following provides a description of an example implementation. According to various example embodiments, the example method and system of FIGS. 1a through 1c may be implemented by a processor of a computer system. The processor may be specially configured, for example, via the execution of program codes instructions. In this regard, the program code instructions may be configured to cause the processor to perform the operations of the example method as described herein.

The user may enter, and a processor may receive, a zip code 401 for a remodeled or new building. The processor may cross-reference Federal, State, and Local tax incentives, rebates, and credits against both the zip code 401, as well as the other objective project data 400, including the building type, the square footage 403, and the budget 404. Further, the zip code 401, the building type 402, and the certification goal 406 may be referenced against a database of utilities and their billing practices (e.g., the sustainability database) and the results may be produced as localized utility programs 422. The zip code 401 may also be cross-referenced against a database of geographically appropriate renewable energy options organized by zip code (e.g., the sustainability database) and the results may be produced as the localized renewable energy options 424. The zip code 401, the building type 402, the square footage 403, and the budget 404 may be cross-referenced against a database, such as the sustainability database, to produce localized product attributes 423, or important performance attributes for that type of structure, with that type of budget, in that given geography. In this manner, a cumulative tax impact 421, the localized utility programs 422, the localized product attributes 423, and the localized renewable energy options 424 may be determined, which may be provided as the material overview 430.

Through a series of questions, or by the user overriding and entering a desired score, an approximate energy scale 413 may be determined. The energy scale 413 facilitates estimating a relative energy efficiency target for the building. Through a series of questions, or by the user overriding and entering a desired score, an approximate sustainability scale 414 may be determined. The sustainability scale 414 facilitates estimating a relative environmental impact target for the building. Through a series of questions, or by the user overriding and entering a desired score, an approximate health scale 415 may be determined. The health scale 415 facilitates estimating the relative potential health impact on occupants, due, for example, to emissive qualities of products target for the building. The energy scale 413, the sustainability scale 414, and the health scale 415 may be provided to the material overview 430 for further analysis.

At the materials overview 430, a user may be presented, via an algorithmic-oriented database, with information relevant to the location, size, type, and budget of the desired building, including the effects of cumulative tax impacts 421, localized utility programs 422, localized product attributes 423, and localized renewable energy options 424. This information from the project overview 420 may be summarized in materials overview 430 in the form of an optimized materials list 431, building recommendations 432, generalized materials recommendations 433. Additional green building information such as ideal or preferred longitudinal and latitudinal axis orientation, ideal or preferred overhang sizes for passive heating and cooling, and useful and beneficial indigenous plants may also be presented.

The objective project data 400 and the subjective project data 410 may be analyzed with respect to the project overview 420 to produce a series of recommendations as provided by the materials overview 430. The recommendations may then be broken down by product class (or product type) and presented in the manufacturer analysis by product division 440 where each product class, or type of construction product, may be associated with groups of manufacturers within that class presented in a hierarchy according to the information contained in the objective project data 400, the subjective project data 410, and the project overview 420. The manufacturers may be presented in an order that is determined based on the user's stated goals. In the manufacturer analysis by product division 440, the most appropriate manufacturers within each product class may be presented in a hierarchy for the user. The user may, in turn, select the category leaders or select one or several manufacturers as preferred manufacturers. When the user confirms the manufacturers within each product class, the information may be sent to the confirmation portal 450.

Within the Confirmation Portal 450, the user may be directed to the selections enumerated in accordance with the user goal 411, including attribute confirmation 451, tentative or firm pricing 452, and product literature from vendors/suppliers 453. Depending on the type of information sought by the user, the messaging portal 460, via an electronic messaging system, may relay to each of the vendors/suppliers, at the appropriate point in the vendors' distribution platform, the request by the user for either attribute confirmation 451 or tentative or firm pricing 452. Each of the manufacturers/suppliers contacted via the messaging portal may then prepare a response and return the responses via the messaging portal 460 to the confirmation portal 450. As a result, the product attributes, the availability at a desired time, and/or the pricing of the products (e.g., at a certain price or within a range) may be confirmed, and the user may be introduced to the manufacturer or supplier. In the event that the user simply desires product literature, the user may receive the literature electronically or in print form. Additionally, the product literature may be stored in the confirmation portal 450 and made available for future review and/or attribute confirmation 451 or tentative or firm pricing 452.

Depending on the user goal 411, the user may be directed to either the specification writing module 470 or project analysis and value propositions 480. Within the specification writing module 470, common sustainable and performance criteria may be determined for each product type among the manufacturers within each product type selections. A specification may then be constructed that is, for example, the most restrictive, yet common to all of the manufacturers chosen. In other words, the sustainable attributes that some or all of the products have in common (e g., minimum common elements) may be determined and written into the specification for the products chosen for the project. Depending on the nature of the project, the manufacturers may or may not be named specifically. Within project analysis and value propositions 490, the user may have the opportunity to compare each of the manufacturers directly against each other given the associated sustainable and performance attributes versus the product price in the price versus attribute analysis 481 and the product-to-product comparisons 462.

In accordance with some example embodiments, the user may then be directed to project modeling 500, where percentage of cost calculations 501 may be determined. The user may be able to review some or all of the product selections for the project. Further, the user may be able to measure the sustainable attributes of the products against the products' prices. The potential number of LEED credits or points available for any collection of manufacturers and products may accordingly be determined. In product mix modeling 502, the user may be able to select various manufacturers and approximate the number of LEED credits or points, or other sustainability rating, available from that mix of manufacturers versus the associated prices. In the best product mix for certification level versus cost 503, a least expensive collection of products to achieve the stated certification goal 406 may be determined. Alternatively, given the budget 404, the number of certification credits or points available given the best mix of manufacturers that meet that budget may be estimated.

The user may also have the option of electronically posting specifications that are produced in the specification writing module 470 with construction plans in the general contractor bid platform 490. The documents forming the construction bid set 491 may be available for multiple invited contractors to review and bid on, as indicated by 491a, 491b, and 491c. Further, the contractors may invite subcontractors 492a, 492b, and 492c to view portions of the bid set and prepare a bid. The user may subsequently make purchasing decisions and proceed with the project.

Project documentation 510 may act as a clearinghouse for the majority of the manufacturer-specific documents required for sustainability certification. The certification documents may relate to the materials sustainable and performance attributes, and the certification documents may be required to receive most certifications. If a manufacturer has not yet provided an indication that the manufacturer is responsible for manufacturing the actual material chosen for the project, the user may indicate which products were the products actually purchased for the project, and the associated purchase cost. Because the attributes of the products and associated cost are known, many of the basic document production capabilities required for certification may be performed.

In manufacturer's documentation and submission 511, documents may be submitted electronically, where possible, to the appropriate certification organization. More specifically, in LEED calculations and submittals 512, the ratios necessary for regional materials may be calculated automatically, which may involve both the point of material extraction and manufacture considered with regard to the project's location. Additional calculations may also be performed related to, for example, recycled content and other attributes within percentage of cost calculations 501, and the calculations may be submitted to LEED online and/or hard copies of the documentation may be prepared for submission.

In addition to documentation necessary for certification, the documentation desired by, for example, the project owner related to the products and materials purchased may also be prepared. In this regard, the product and material warranty information and operating manuals may be prepared in operating manuals, commissioning templates, warranty information 513. The information and manuals may contain commissioning reports appropriate for the products or materials included in the building.

The method and system of FIG. 1a-1c may include additional operations and modules that may be implemented to execute the additional operations. Some examples of additional operations and associated modules may include the following.

The method and system may include a certification workflow documentation module, which may step a user through each certification (e.g., LEED or Energy Star) credit or rating category within a construction project. The module may model material options against a range of potential ratings. Historical data may be utilized to perform an analysis of the most cost-effective rating categories within the certification or sustainability rules, and may guide a user through a range of choices and selections to maximize ratings and point scores while minimizing costs within each category. Further, on behalf of the manufacturer, documentation may be generated that is needed for any selected product to document the sustainable attributes as represented by the manufacturer.

Additionally, a LEED/government agency project management module may be included. The LEED/government agency project management module may allow users, such as the AEC (Architecture/Engineering/Construction) community, to consider any additional requirements for federal or state project requirements, such as the Buy American Act, The Bio-Based Purchasing Act (Farm Security & Rural Investment Act Sect. 9002), and a number of federal and state purchasing programs. As such, users may write non-proprietary specifications for each product class, delineating a bottom-line cost for the three most appropriate manufacturers, possibly without naming the manufactures in the specifications.

A modeling integration module may also be included that allows a user to automatically extract and analyze every building product category incorporated into an Autodesk REVIT design, or similar BIM (building information modeling)-oriented design platform. The modeling integration module may allow a project designer can quickly move from a schematic design of a building to the appropriate materials, and manufacturers of those materials, in order to obtain valuable analysis of the LEED materials points of a building. Further, the module may prompt the user when there are more cost-effective ways for points or ratings to be obtained.

A BIM population module may also be included that allows a user to populate any BIM with manufacturer-specific sustainable and performance material information, which may be particularly useful where no proprietary BIM of an object exists. A user may construct an information-rich electronic version of a building, and deliver the electronic version of the building to, for example, the building owner at the conclusion of a project. With this information, the aggregate level of any number of sustainable and performance features may be determined in an electronic format. Armed with this information, a building may receive commissioning and advanced commissioning in a more expedient fashion. Moreover, a fully-digitized representation of a building may be generated, allowing for efficient and effective researching, documentation, and modeling of building attributes.

A Building Owners and Managers Association (BOMA) module may also be included that allows building owners, operators, and maintenance personnel to have a proactive, and possibly a real-time or near real-time view, of the materials and systems within a given building. As such, through the functionality of this module, maintenance and repair analysis may be conduction on the materials and construction products within a structure. Additionally, related manufacturer warranty information may be queried.

A retrofit/existing building module may also be included, possibly as an extension of the BOMA module, which allows a user to model the existing materials, products, and systems within a given building. The module may be configured to simulate the relative impact of any upgrades, at any future point in time, in relation to sustainability, efficiency, health, and price.

A carbon/LCA (life cycle assessment) module may be included that performs carbon and life cycle assessment and analysis thereby allowing a user to compute the relative level of carbon (and/or any number of additional LCA criteria) within a building. The module may provide for the computation of LCA/Carbon as products leave a manufacturer's facility, the impact of the transportation to the project location, and the anticipated or actual operation of the building over a stated period of time.

An efficiency modeling versus baseline module may also be included, which provides real-time or near real-time access to the actual water and energy usage within a building versus an anticipated or planned usage, on a component, system, and overall building basis. Via this functionality, particular systems, or the interrelation thereof, may be analyzed to determine whether the systems are functioning properly. In addition, in consideration of fluctuating energy and water prices, the module may provide cost/benefit analyses of various system and product upgrades.

FIG. 2 provides an illustration of a block diagram of another example embodiment of the present invention. According to various example embodiments, the sustainability rating engine 140 may be implemented by a processor, via instructions stored on a memory device, to perform the operations described in FIGS. 1a-1c. Additionally, or alternatively, the sustainability rating engine 140 may be configured to implement some subset of the functionality described with respect to FIGS. 1a-1c. The sustainability rating engine 140 may receive a number of inputs and provide a number of outputs according to various example embodiments. The sustainability rating engine 140 may be configured to apply sustainability rules as defined, for example, in various sustainability certification standards as described above. The sustainability rating engine 140 may be configured to receive a number of information inputs and provide information outputs through application of sustainability rules and interaction with the sustainability database 150.

The sustainability rating engine 140 may access a sustainability database 150 to retrieve data, such as construction product sustainability information as well as other information, to facilitate the performance of operations by the sustainability rating engine 140 such as, determining a sustainability rating. The sustainability database may store many different types of sustainability and other data about products. Types of data housed in the sustainability data 150 may include location-based tax incentive information 200, local-utility energy policies 201, location-based renewable energy information, and product specifications 203. Location-based tax incentive information 200 may include information regarding the federal, state, and local tax incentives, rebates, and credits organized by geographic area (e.g., zip code, city, county, state, or the like). Local utility energy policies 201 may include information about the practices and programs of the utilities organized by geographic area. For example, the local utility energy policies 201 may include information describing electricity purchasing programs, green power programs, conservation programs, and the like. The local utility energy policies 201 may also include data and statistics regarding the type of power generation practices used by the utilities.

The location-based renewable energy information 202 may be information indicating the renewable energy practices that are suitable for various geographic areas. For example, using a zip code to query the location-based renewable energy information 202, a user may determine that solar panels may be more efficient and effective than a wind turbine in a given geographic area. Further, the location-based renewable energy information 202 may be queried in conjunction with the local utility energy policies 201 to determine a renewable energy option (i.e., solar panels, wind turbines, or the like) that satisfies a particular power buy-back program for a local utility. The sustainability database 150 may also include construction product specifications 203. The construction product specifications 203 may include construction product attribute information including sustainability data. The sustainability data may include information regarding, for example, the location of raw material extraction and the location of manufacturing, product-based ratings (e.g., insulation ratings), raw material certifications (e.g., certified forestry programs), amount of recycled content, amount of reused content, amount of renewable material, emissive qualities, and other information that may be used to determine a sustainability rating for a construction product.

For inputs, the sustainability rating engine 140 may receive one or more of the following: a product type 205, a product quantity 210, a budget 215 (e.g., for a product type or for a total project), a type of user 220 for the completed construction project (e.g., commercial, federal government, state or local government, or the like), sustainability standard selections 230, location information 240, and sustainability criteria 250. According to some example embodiments, additional or alternative inputs may be utilized based on, for example, the sustainability rules that are to be applied. The inputs may be categorized as objective or subjective project data. According to various example embodiments, the inputs provided to the sustainability rating engine 140 may be directly provided by a user, for example via a user interface, the inputs may be uploaded from an existing data set, and the inputs may be received as resultant data from operations performed by, for example, application being implemented by a processor.

The product type 205 may be a description of a type of construction product that is desired for a given construction project. Examples of product types may include flooring, wall board, insulation, cement, lumber, air conditioning units, appliances, furniture, garden plants, and the like. The product quantity 210 may be an amount of a particular product type that is desired (e.g., square footage of flooring, palettes of wallboard, etc.). The budget 215 may be a monetary amount allocated for a particular construction product or for an overall project. The type of user 220 may be a description of the entity that will be using the structure to be constructed. For example, the type of user 220 may be commercial or governmental (e.g., federal, state/local, or the like), as well as it may represent and industry (e.g. healthcare, education, or the like), in addition to the usage (e.g. hospital) within an industry.

Further, the sustainability standard selection 230 may indicate which certifying entity's sustainability rules are to be applied to determine the outputs, such as the sustainability rating 260. In this regard, the sustainability standard selection 230 may indicate that LEED certification rules are to be applied, Energy Star rules, or the like. According to some example embodiments, the sustainability standard selection 230 may be predetermined and static for a given implementation. The location information 240 may describe the geographic location of the construction site. According to some example embodiments, the location information 240 may be provided in the form of a zip code. Additionally, the sustainability rating engine 140 may receive construction project sustainability criteria 250. The construction project sustainability criteria 250 may include for example, target sustainability ratings for individual construction products or a target sustainability rating for an entire project, as well as other criteria that may be used to determine outputs of the sustainability rating engine 140.

The outputs that the sustainability rating engine 140 may generate include a sustainability rating 260, product specifications 270, product provider information 270, and project options/alternatives 290. The sustainability rating engine 140 may include or interface with a bidding/request for quote manager 170, which may be configured to perform the functionality described with respect to the general contractor bid platform 490 of FIG. 1c. The bidding/request for quote manager 170, which may also be implemented by a processor, may be configured to receive the outputs from the sustainability rating engine 140 (e.g., the sustainability rating 260 or the product specification 270), and process a bid from a contractor or subcontractor for a construction product.

The sustainability rating 260 may be a score, a level (e.g., a certification level), or the like for a product or an entire project, that is determined based on sustainability rules. To determine the sustainability rating 260, the sustainability rating engine 140 may be configured to receive the product type 205 and the product quantity 210, and query the sustainability database 150 using the product type 205. The query may return the identity of a candidate construction product and sustainability data associated with the candidate construction product. Based on the sustainability data, the sustainability rating 260 may be determined through application of sustainability rules determined, for example, by the sustainability standard selection 230.

According to some example embodiments, upon determining a sustainability rating 260 for a candidate construction product, a user may wish to contact a supplier or manufacturer of the candidate construction product, for example, to begin the process of purchasing the candidate construction product. In this regard, the sustainability rating engine 140 may be configured to provide product provider information 280 to a user by retrieving the information, for example, from the sustainability database 150.

For an example scenario involving the determination of a sustainability rating, a product type 205 may be received that describes hardwood flooring for a construction project requiring a certain square footage of flooring. The sustainability rating engine 140 may be configured to query the sustainability data for hardwood flooring candidate products. Upon identifying one or more candidate hardwood flooring candidates, the sustainability rating engine 140 may be configured to retrieve sustainability data associated with each of the hardwood flooring candidates. In this regard, the sustainability data may indicate the raw material certifications (e.g., certified forestry programs), amount of recycled content, amount of reused content, amount of renewable material, and emissive qualities for the candidate construction products. Sustainability rules may be applied to the sustainability data for a particular hardwood flooring candidate to determine the sustainability rating for that candidate. In this regard, for example, the sustainability rules may indicate that the inclusion of a threshold amount of recycled material, as indicated in the sustainability data, may award a sustainability rating to the hardwood flooring candidate. Further, the sustainability rules may award the construction product an improved sustainability rating if the same hardwood flooring candidate includes a threshold amount of reused content.

The location information 240 may also be considered in the determination of the sustainability rating 260. In this regard, according to some example embodiments, the distance between the extraction location of raw materials (e.g., the forest, quarry, etc.) and the construction site, and the distance between the manufacturing location (e.g., the manufacturing plant) and the construction site may also be a factor that improves or worsens a sustainability rating 260. For example, if both the extraction location and the manufacturing location are within 500 miles of the construction site, a maximum sustainability rating may be determined.

Additionally, based on the location information 240, and possibly the type of user 220, the sustainability rating engine 140 may be configured to identify government incentives for a given construction project. For example, a state tax credits may available for construction projects that achieve a particular threshold sustainability or certification. As such, the sustainability rating engine 140 may be configured to query the sustainability database 150 to identify government incentives based on a sustainability rating for at least a construction product, and provide information regarding the government incentives in the form of project recommendations 290.

Based on the forgoing, a sustainability rating 260 for a candidate construction product may be determined for a given construction product by the sustainability rating engine 140. Additionally, the sustainability rating engine 140 may also be configured to determine a sustainability rating for a multiple candidate construction products (e.g., “n” hardwood flooring candidates) in the same manner. Upon determining the sustainability ratings, the sustainability rating engine 140 may be configured to determine whether the either of the sustainability ratings satisfy the construction project sustainability criteria 250. For example, the construction project sustainability criteria may indicate a target sustainability rating for hardwood flooring as being 3 credits. The sustainability rating engine 140 may be configured to determine the sustainability ratings and determine which of the sustainability rating satisfies the criteria of having a sustainability rating of at least 3 credits. The results of the determination may be output, for example, to a user interface display as project recommendations 290.

Further, as part of a project analysis, the sustainability rating engine 150 may be configured to determine sustainability ratings for candidate construction products having different product types (e.g., a sustainability rating for hardwood flooring and a sustainability rating for wallboard). The sustainability rating engine 140 may be configured to aggregate two or more sustainability ratings to determine a total project sustainability rating. The sustainability rating engine 140 may also be configured to determine whether the total project sustainability rating satisfies a target total project sustainability rating defined by the construction project sustainability criteria 250. The sustainability rating engine 140 may also be configured to determine that the total project sustainability rating more than satisfies or exceeds a target total project sustainability rating. For example, the sustainability rating engine 140 may be configured to determine an amount by which the target total project sustainability rating has been exceeded, and provide project recommendations for selecting different candidate construction products that would cause the target total project sustainability rating to continue to be satisfied, while also reducing or minimizing the cost of the construction project.

In some example embodiments, the construction project sustainability criteria 250 may include future cost savings criteria or a payback period requirement. For example, the construction project sustainability criteria 250 may include a requirement that ceiling and wall insulation for the construction project be of a type that provides a particular amount of savings for heating and cooling over the average insulation, and the payback for purchasing higher priced insulation must be realized within a particular amount of time. Sustainability data associated with a candidate construction product, retrieved from the sustainability database 150, may be used by the sustainability rating engine 140 to determine whether a particular candidate construction product satisfies the future cost saving criteria and/or the pay-back period requirement. The sustainability rating engine 140 may also provide the results of the determination as project recommendations 250.

The sustainability rating engine 140 may also be configured to generate and provide product specifications 270. In this regard, some construction products may need to be specially ordered and manufactured for a particular application within a construction project. These types of construction products may require the creation and submission of a product specification to the manufacturer of the product to have the appropriate product manufactured. Based on the construction project sustainability criteria 250, including, for example, a target sustainability rating for a particular product type, the sustainability rating engine 140 may be configured to generate, and possibly submit, a construction product specification 270. A manufacturer may assemble a construction product that satisfies the criteria set forth in the construction project sustainability criteria based on the specification.

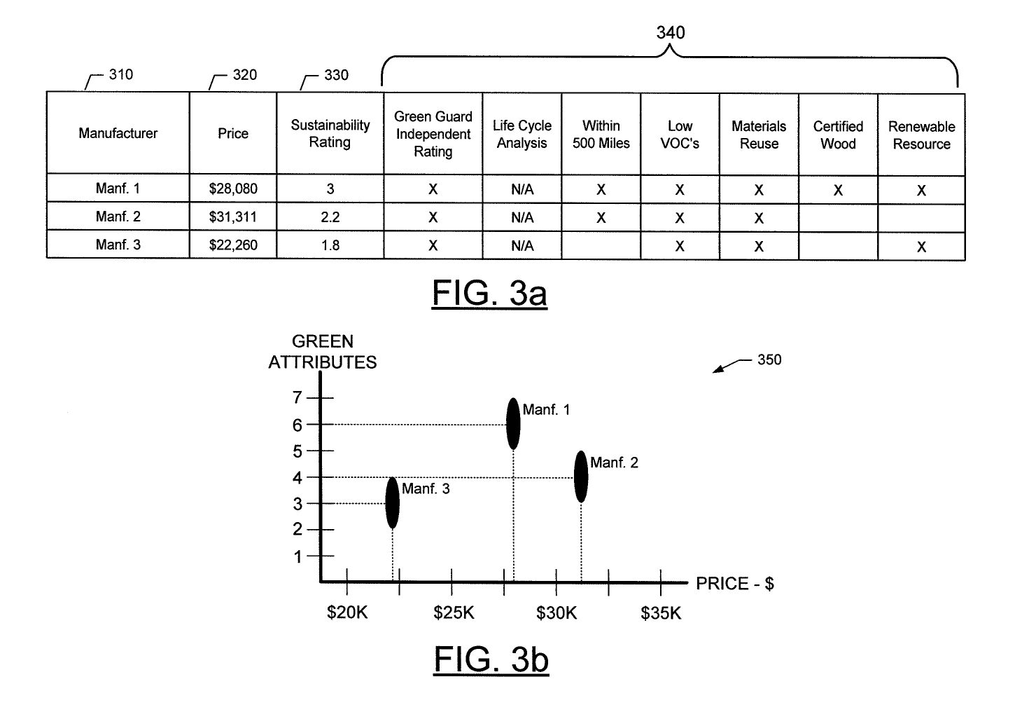

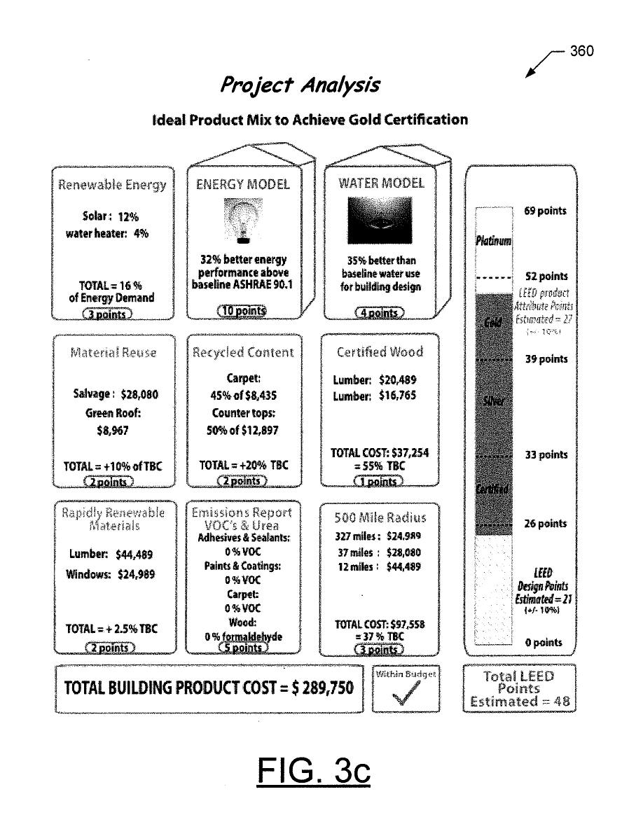

In view of the forgoing, FIGS. 3a through 3c provide illustrations of example outputs that may be generated and provided by the sustainability rating engine 140. FIG. 3a illustrates an example candidate construction product comparison table 300 according to various example embodiments. The comparison table 300 provides a user with various pieces of sustainability and other information regarding the candidate construction products to assist the user in selecting a desired product. The comparison table 300 includes the manufacturer's identity in column 310, the price of the candidate construction product in column 320, and the sustainability ratings in column 330. In the area 340, additional sustainability and other information may be provided to the user in a tabular format to facilitate comparing the various aspects of the candidate construction products.

FIG. 3b illustrates an output of the sustainability rating engine 140 in the form of a graphical representation of the candidate construction products. Candidate construction products may be plotted on a graph 350 having cost on the x-axis and an aggregated “green attributes” value on the y-axis. The green attributes value may be determined based on a number of factors, such as the sustainability rating for the candidate construction products.

FIG. 3c illustrates a project analysis overview 360 for a construction project in accordance with various example embodiments. In this regard, the project analysis overview 360 may provide a breakdown of the various project attributes that may contribute to a total project sustainability rating and provide an indication of the aggregated total project sustainability rating. Using the broken down aspects of the construction project, a user may readily identify the areas where modifications may be made to impact the sustainability rating for that aspect, as well as the aggregated total project sustainability rating.

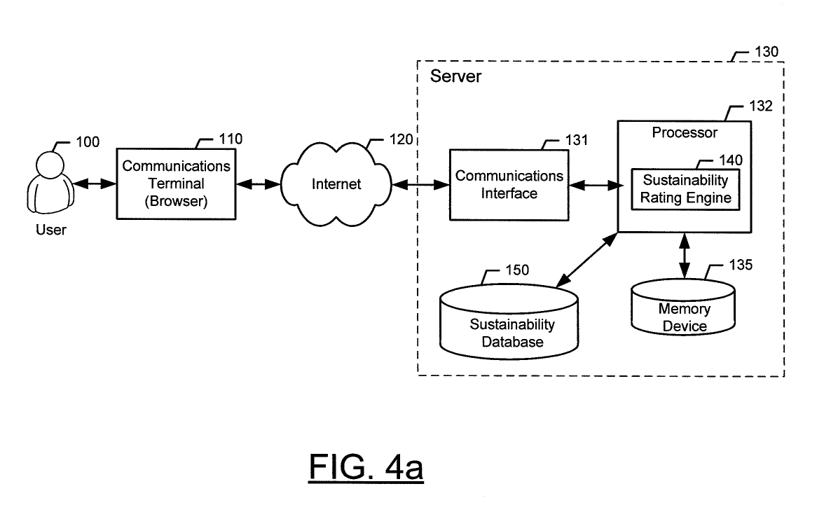

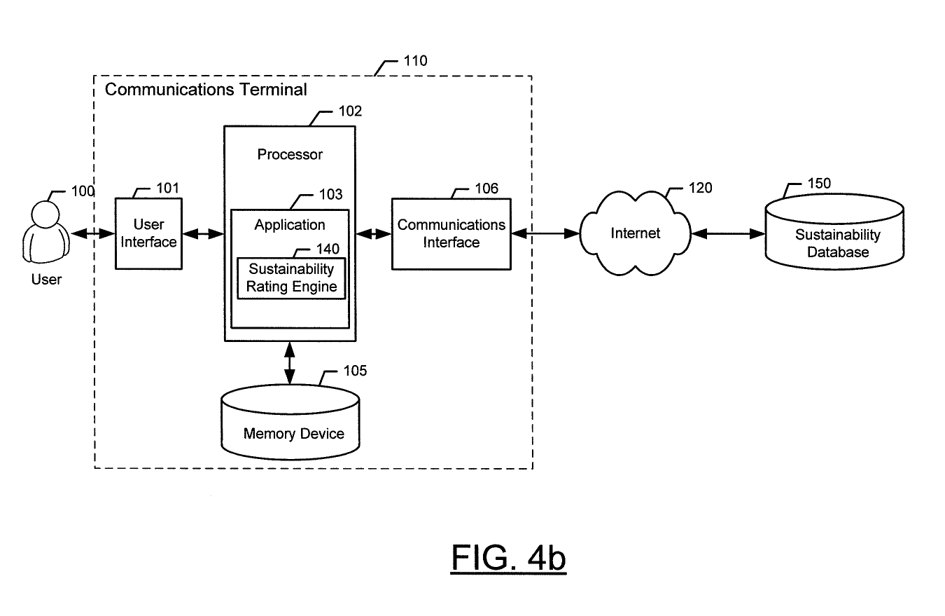

FIGS. 4a and 4b depict systems according to example embodiments of the present invention indicating how the sustainability rating engine 140 may be implemented. In this regard, FIG. 4a illustrates the implementation of the sustainability rating engine 140 on the processor 132 of a server 130, and being accessed via a browser of communications terminal 110. The user 100 may interface with the communications terminal 110, which may support wired or wireless communications. The communications terminal 110 may implement a web browser to access the server 103 and the sustainability rating engine 140 via a network, such as the Internet 120. For example, the server 130 may host a website that provides an interface to the sustainability rating engine 140. In addition to implementing the sustainability rating engine 132, the server 130 may include the sustainability database 150 which may be accessed by the processor 132 for implementing the sustainability rating engine 140. In some example embodiments, the sustainability database 150 may be store on memory device 135.

FIG. 4b illustrates an alternative system where the sustainability rating engine 140 is implemented by the communications terminal 110 within an application 103 that is, in turn, executed by the processor 102. The application 103 may be a project or architectural design software application, such as Autodesk™ REVIT™ or a building information modeling (BIM) software, and the sustainability rating engine 140 may be implemented as a plug-in or add-on feature set to application 103. To access the sustainability database 150, the sustainability rating engine 140 may utilize a network or Internet connection.

According to various example embodiments, the communications terminal 110 and the server 130 may be, or may be included within, a computing device that supports and/or utilizes network communications and is configured as described above to perform, when configured appropriately, the functionality of the sustainability rating engine 140. In some example embodiments, the communications terminal 110 and the server 130 may be configured to perform the functionality described above, and may include or be included within a computer or a mobile terminal such as a mobile telephone, personal computing device, or the like.

The communications terminal 110 and the server 130 respectively include or are otherwise in communication with processors 102 and 132, memory devices 105 and 135, and communications interfaces 106 and 131. The communications terminal 110 also includes a user interface 101. The processors 102 and 132 may be embodied as various means for implementing various functionality of example embodiments of the present invention including, for example, microprocessors, coprocessors, controllers, special-purpose integrated circuits such as, for example, ASICs (application specific integrated circuits), FPGAs (field programmable gate arrays), or hardware accelerators, processing circuitry or the like. According to one example embodiment, processors 102 and 132 may be representative of a plurality of processors operating in concert. The processors 102 and 132 may, but need not, include one or more accompanying digital signal processors. In some example embodiments, the processors 102 and 132 are configured to execute instructions stored in respective memory devices 105 and 135 or instructions otherwise accessible to the processors 102 and 132. Whether configured as hardware or via instructions stored on a computer-readable storage medium, or by a combination thereof, the processors 102 and 132 may be an entity capable of performing operations according to embodiments of the present invention while configured accordingly. Thus, in example embodiments where the processors 102 and 132 are embodied as an ASIC, FPGA, or the like, the processors 102 and 132 are specifically configured hardware for conducting the operations described herein. Alternatively, in example embodiments where the processors 102 and 132 are embodied as an executor of instructions stored on a computer-readable storage medium, the instructions specifically configure the processors 102 and 132 to perform the algorithms and operations described herein. In some example embodiments, the processors 102 and 132 are processors of a specific device (e.g., communications terminal or server) configured for employing example embodiments of the present invention by further configuration of the processors 102 and 132 via executed instructions for performing the algorithms and operations described herein.

The memory devices 105 and 135 may be one or more computer-readable storage media that may comprise volatile and/or non-volatile memory. The memory devices 105 and 135 may be contrasted with a computer-readable transmission medium, such as a propagating signal. In some example embodiments, the memory devices 105 and 135 comprise Random Access Memory (RAM) including dynamic and/or static RAM, on-chip or off-chip cache memory, and/or the like. Further, memory devices 105 and 135 may comprise non-volatile memory, which may be embedded and/or removable, and may comprise, for example, read-only memory, flash memory, magnetic storage devices (e.g., hard disks, floppy disk drives, magnetic tape, etc.), optical disc drives and/or media, non-volatile random access memory (NVRAM), and/or the like. Memory devices 105 and 135 may comprise a cache area for temporary storage of data. In this regard, some or all of memory devices 105 and 135 may be included within the respective processors 102 and 132.

Further, the memory devices 105 and 135 may be configured to store information, data, applications, computer-readable program code instructions, or the like for enabling the processors 102 and 132 to carry out various functions in accordance with example embodiments of the present invention described herein. For example, the memory devices 105 and 135 could be configured to buffer input data for processing by the processors 102 and 132. Additionally, or alternatively, the memory devices 105 and 135 may be configured to store instructions for execution by the respective processors 102 and 132.

The communication interfaces 106 and 131 may be any device or means embodied in either hardware, a computer program product, or a combination of hardware and a computer program product that is configured to receive and/or transmit data from/to a network and/or any other device or module in communication with the communications terminal 110 or the server 130. Processors 102 and 132 may also be configured to facilitate communications via the communications interface by, for example, controlling hardware included within the respective communications interfaces 106 and 131. In this regard, the communication interfaces 106 and 131 may support wired or wireless communications on a network, such as the Internet 120.

The user interface 101 of the communications terminal 110 may be in communication with the processor 102 to receive user input via the user interface 101 and/or to present output to a user as, for example, audible, visual, mechanical or other output indications. The user interface 101 may comprise, for example, a keyboard, a mouse, a joystick, a display (e.g., a touch screen display), a microphone, a speaker, or other input/output mechanisms.

The sustainability rating engine 140 may be any means or device embodied, partially or wholly, in hardware, a computer program product, or a combination of hardware and a computer program product, such as processors 106 or 131 implementing stored instructions to configure the communications terminal 110 or the server 130, or hardware configured processors 102 and 132, that are configured to carry out the functions of the communications terminal 110 and the server 130 as described herein. In an example embodiment, the processors 102 and 132 include, or control, the sustainability rating engine 140. The sustainability rating engine 140 may be, partially or wholly, embodied as processors similar to, but separate from processors 102 and 132. In this regard, the sustainability rating engine 140 may be in communication with the processors 102 and 132. In various example embodiments, the sustainability rating engine 140 may, partially or wholly, reside on distributed apparatuses such that some or all of the functionality of the sustainability rating engine 140 may be performed by a first apparatus, and the remainder of the functionality of the sustainability rating engine 140 may be performed by one or more other apparatuses.

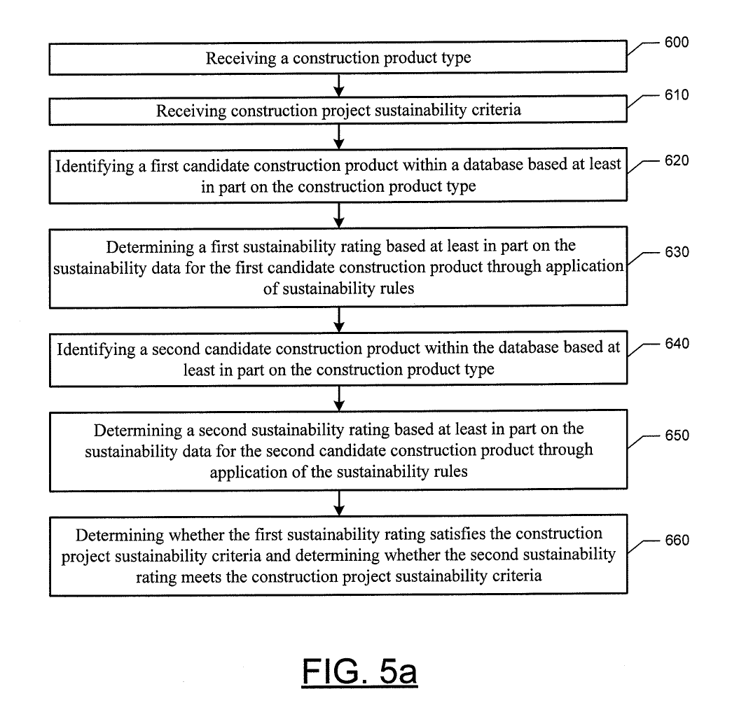

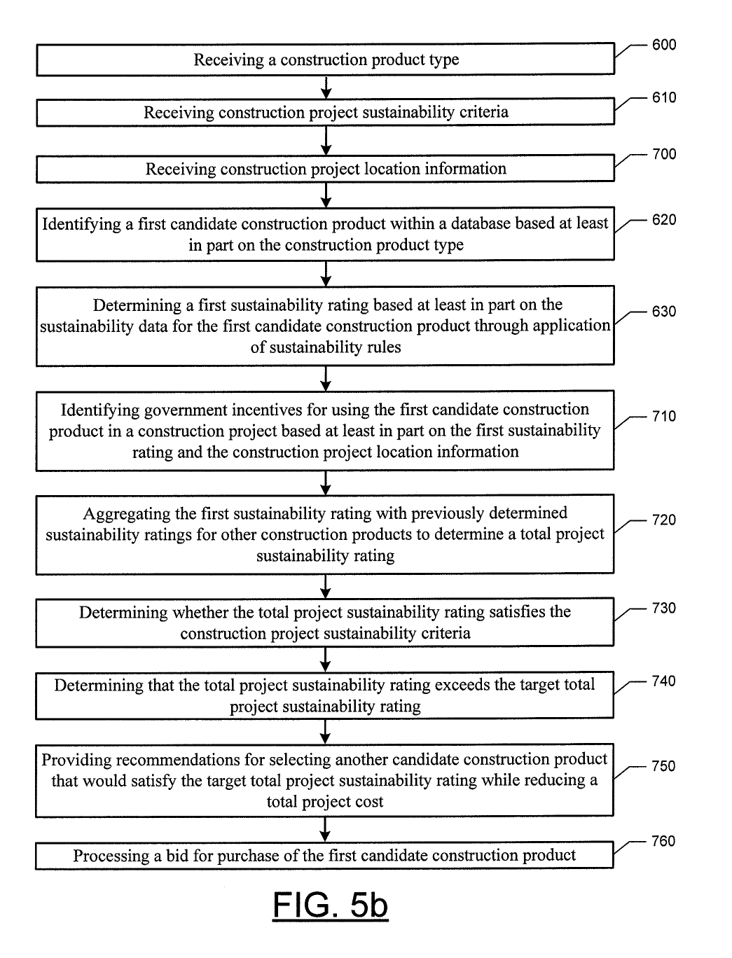

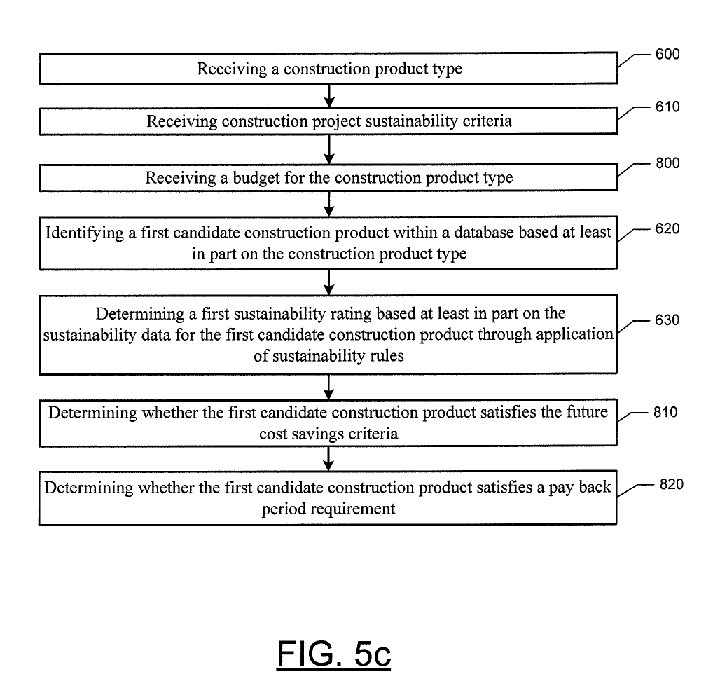

FIG. 5a illustrates a first example method according to various example embodiments of the present invention. The example method of FIG. 5a includes receiving a construction product type at 600 and receiving construction project sustainability criteria at 610. The example method further includes, at 620, identifying a first candidate construction product within a database based at least in part on the construction product type. According to some example embodiments, a provider or supplier of the first candidate construction product may also be determined or identified. The first candidate construction product may be associated with sustainability data for the first candidate construction product. An example embodiment also includes determining a first sustainability rating based at least in part on the sustainability data for the first candidate construction product through application of sustainability rules at 630, and identifying a second candidate construction product within the database based at least in part on the construction product type at 640. The second candidate construction product may be associated with sustainability data for the second candidate construction product. At 650, the example method includes determining a second sustainability rating based at least in part on the sustainability data for the second candidate construction product through application of the sustainability rules, and, at 660, determining whether the first sustainability rating satisfies the construction project sustainability criteria and determining whether the second sustainability rating satisfies the construction project sustainability criteria.

FIG. 5b illustrates another example method according to example embodiments of the present invention. In addition to including the operations of 600, 610, 620, 630, and 640 of FIG. 5a, the example method of FIG. 5b may include receiving construction project location information at 700. When determining the first sustainability rating at 640 includes determining a first sustainability rating based at least in part on the construction project location information through application of sustainability rules, the example method further includes, at 710, identifying government incentives for using the first candidate construction product in a construction project based at least in part on the first sustainability rating and the construction project location information. At 720, the example method includes aggregating the first sustainability rating with previously determined sustainability ratings for other construction products to determine a total project sustainability rating, and, at 730, determining whether the total project sustainability rating satisfies the construction project sustainability criteria. Further, when the construction project sustainability criteria includes a target total project sustainability rating, an example embodiment also includes, at 740, determining that the total project sustainability rating exceeds the target total project sustainability rating, and, at 750, providing recommendations for selecting another candidate construction product that would satisfy the target total project sustainability rating, while reducing a total project cost. The example method may also include processing a bid for purchase of the first candidate construction product 760.

FIG. 5c illustrates another example method according to example embodiments of the present invention. In addition to including the operations of 600, 610, 620, 630, and 640 of FIG. 5a, the example method of FIG. 5c may also include receiving a budget for the construction product type at 800. When receiving construction project sustainability criteria at 620, includes receiving future cost savings criteria, an example embodiment further includes determining whether the first candidate construction product satisfies the future cost savings criteria, at 810, based at least in part on the sustainability data for the first candidate construction product. When receiving construction project sustainability criteria at 620, includes receiving a pay-back period requirement, an example embodiment further includes determining whether the first candidate construction product satisfies the pay-back period requirement, at 820, based at least in part on the sustainability data for the first candidate construction product and the budget for the construction product type.

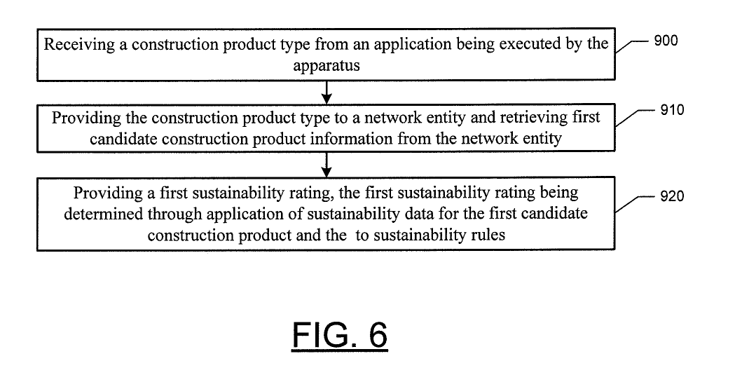

FIG. 6 illustrates yet another example method in accordance with various example embodiments. The example method of FIG. 6 includes receiving a construction product type from an application being executed by the apparatus at 900, providing the construction product type to a network entity, and retrieving first candidate construction product information from the network entity at 910. An example embodiment also includes, at 920, providing a first sustainability rating, the first sustainability rating being determined through application of sustainability data for the first candidate construction product and the to sustainability rules.

FIGS. 1a-1c, 2, 5a-5c, and 6 illustrate operational diagrams of example systems, methods, and/or computer program products according to example embodiments of the invention. It will be understood that each operation of the operational diagrams, and/or combinations of operations in the operational diagrams, can be implemented by various means. Means for implementing the operations of the operational diagrams, combinations of the operations in the operational diagrams, or other functionality of example embodiments of the present invention described herein may include hardware, and/or a computer program product including a computer-readable storage medium (as opposed to a computer-readable transmission medium) having one or more computer program code instructions, program instructions, or executable computer-readable program code instructions stored therein. Program code instructions may be stored on a memory device, such as memory devices 105 and 135, of an example apparatus, such as communications terminal 110 and server 130, and executed by a processor, such as the processors 102 or 132. Such program code instructions may be loaded onto a computer or other programmable apparatus (e.g., processors 102 and 132, memory devices 105 and 135, or the like) from a computer-readable storage medium to produce a particular machine, such that the particular machine becomes a means for implementing the functions specified in the operational diagrams' operations. These program code instructions may also be stored in a computer-readable storage medium that can direct a computer, a processor, or other programmable apparatus to function in a particular manner to thereby generate a particular machine or particular article of manufacture. The instructions stored in the computer-readable storage medium may produce an article of manufacture, where the article of manufacture becomes a means for implementing the functions specified in the operational diagrams' operations. The program code instructions may be retrieved from a computer-readable storage medium and loaded into a computer, processor, or other programmable apparatus to configure the computer, processor, or other programmable apparatus to execute operations to be performed on or by the computer, processor, or other programmable apparatus. Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together. Execution of the program code instructions may produce a computer-implemented process such that the instructions executed by the computer, processor, or other programmable apparatus provide operations for implementing the functions specified in the operational diagrams' operations.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of steps, elements, and/or materials than those explicitly described above are also contemplated as may be set forth in some of the appended claims. Accordingly, the specification and drawings are to be regarded in an illustrative rather than restrictive sense. Although specific terms are employed herein, they are used in a generic and descriptive sense only and not for purposes of limitation.

What is claimed is:

1. A method comprising:
receiving a construction product type;
identifying a first candidate construction product within a database based at least in part on the construction product type, the first candidate construction product being associated with sustainability data for the first candidate construction product;
determining, via a processor, a first sustainability rating based at least in part on the sustainability data for the first candidate construction product through application of sustainability rules.

2. The method of claim 1, further comprising:
receiving construction project sustainability criteria;
identifying a second candidate construction product within the database based at least in part on the construction product type, the second candidate construction product being associated with sustainability data for the second candidate construction product;
determining a second sustainability rating based at least in part on the sustainability data for the second candidate construction product through application of the sustainability rules; and
determining whether the first sustainability rating satisfies the construction project sustainability criteria.

3. The method of claim 1, further comprising receiving construction project location information; and
wherein determining a first sustainability rating includes determining a first sustainability rating based at least in part on the construction project location information through application of the sustainability rules.

4. The method of claim 3 further comprising identifying government incentives for using the first candidate construction product in a construction project based at least in part on the first sustainability rating and the construction project location information.

5. The method of claim 1, wherein identifying a first candidate construction product includes identifying a provider of the first candidate construction project; and wherein the method further comprises processing a bid for purchase of the first candidate construction product.

6. The method of claim 1 further comprising:
receiving construction project sustainability criteria;
aggregating the first sustainability rating with previously determined sustainability ratings for other construction products to determine a total project sustainability rating; and
determining whether the total project sustainability rating satisfies the construction project sustainability criteria.

7. The method of claim 6, wherein receiving the construction project sustainability criteria includes receiving the construction project sustainability criteria, the construction project sustainability criteria including a target total project sustainability rating; and
wherein the method further comprises:
determining that the total project sustainability rating exceeds the target total project sustainability rating; and
providing alternatives for selecting another candidate construction product that would satisfy the target total project sustainability rating while reducing a total project cost.

8. The method of claim 1 further comprising:
receiving construction project sustainability criteria, the construction project sustainability criteria including future cost savings criteria;
determining whether the first candidate construction product satisfies the future cost savings criteria, based at least in part on the sustainability data for the first candidate construction product.

9. The method of claim 1 further comprising:
receiving a budget for the construction product type; and
receiving construction project sustainability criteria, the construction project sustainability criteria including a pay-back period requirement;
determining whether the first candidate construction product satisfies the pay-back period requirement, based at least in part on the sustainability data for the first candidate construction product and the budget for the construction product type.

10. The method of claim 1 further comprising receiving construction project sustainability criteria; and
wherein identifying the first candidate construction product within a database based at least in part on the construction product type includes generating a specification for the production of the first candidate construction product, the first candidate construction product having sustainability attributes that satisfy the construction project sustainability criteria.

11. A computer-readable storage medium having executable computer-readable program code instructions stored therein, the computer-readable program code instructions configured to cause an apparatus to perform:
receiving a construction product type;
identifying a first candidate construction product within a database based at least in part on the construction product type, the first candidate construction product being associated with sustainability data for the first candidate construction product;
determining a first sustainability rating based at least in part on the sustainability data for the first candidate construction product through application of sustainability rules.

12. The computer-readable storage medium of claim 11, wherein the instructions are further configured to cause the apparatus to perform:
receiving construction project sustainability criteria;
identifying a second candidate construction product within the database based at least in part on the construction product type, the second candidate construction product being associated with sustainability data for the second candidate construction product;
determining a second sustainability rating based at least in part on the sustainability data for the second candidate construction product through application of the sustainability rules; and
determining whether the first sustainability rating satisfies the construction project sustainability criteria.

13. The computer-readable storage medium of claim 11, wherein the instructions are further configured to cause the apparatus to perform receiving construction project location information; and
wherein the instructions configured to cause the apparatus to perform determining a first sustainability rating include being configured to cause the apparatus to perform determining a first sustainability rating based at least in part on the construction project location information through application of the sustainability rules.

14. The computer-readable storage medium of claim 13, wherein the instructions are further configured to cause the apparatus to perform identifying government incentives for using the first candidate construction product in a construction project based at least in part on the first sustainability rating and the construction project location information.

15. The computer-readable storage medium of claim 11, wherein the instructions configured to cause the apparatus to perform identifying a first candidate construction product include being configured to cause the apparatus to perform identifying a provider of the first candidate construction project; and
wherein the instructions are further configured to cause the apparatus to perform processing a bid for purchase of the first candidate construction product.

16. The computer-readable storage medium of claim 11, wherein the instructions are further configured to cause the apparatus to perform:
receiving construction project sustainability criteria;
aggregating the first sustainability rating with previously determined sustainability ratings for other construction products to determine a total project sustainability rating; and
determining whether the total project sustainability rating satisfies the construction project sustainability criteria.

17. The computer-readable storage medium of claim 16, wherein the instructions configured to cause the apparatus to perform receiving the construction project sustainability criteria include being configured to cause the apparatus to perform receiving the construction project sustainability criteria, the construction project sustainability criteria including a target total project sustainability rating; and
wherein the instructions are further configured to cause the apparatus to perform:
determining that the total project sustainability rating exceeds the target total project sustainability rating; and
providing recommendations for selecting another candidate construction product that would satisfy the target total project sustainability rating while reducing a total project cost.

18. The computer-readable storage medium of claim 11, wherein the instructions are further configured to cause the apparatus to perform:
receiving construction project sustainability criteria, the construction project sustainability criteria including future cost savings criteria;
determining whether the first candidate construction product satisfies the future cost savings criteria, based at least in part on the sustainability data for the first candidate construction product.

19. The computer-readable storage medium of claim 11, wherein the instructions are further configured to cause the apparatus to perform:
receiving construction project sustainability criteria; and
generating a specification for the production of a target construction product, the target construction product having sustainability attributes that satisfy the construction project sustainability criteria.

20. The computer-readable storage medium of claim 11, wherein the instructions are further configured to cause the apparatus to perform:
receiving a budget for the construction product type; and
receiving construction project sustainability criteria, the construction project sustainability criteria including a pay-back period requirement;
determining whether the first candidate construction product satisfies the pay-back period requirement, based at least in part on the sustainability data for the first candidate construction product and the budget for the construction product type.

21. The computer-readable storage medium of claim 11, wherein the instructions configured to cause the apparatus to perform receiving a construction product type include being configured to perform receiving a construction product type via a network connection from a communications terminal executing a browser application.

22. The computer-readable storage medium of claim 11, wherein the instructions are further configured to cause the apparatus to perform receiving construction project sustainability criteria; and
wherein the instructions configured to cause the apparatus to perform identifying the first candidate construction product within a database based at least in part on the construction product type include being configured to cause the apparatus to perform generating a specification for the production of the first candidate construction product, the first candidate construction product having sustainability attributes that satisfy the construction project sustainability criteria.

23. A computer-readable storage medium having executable computer-readable program code instructions stored therein, the computer-readable program code instructions configured to cause an apparatus to perform:
receiving a construction product type from an application being executed by the apparatus;
providing the construction product type to a network entity and retrieving first candidate construction product information from the network entity; and
providing a first sustainability rating, the first sustainability rating being determined through application of sustainability data for the first candidate construction product and the to sustainability rules.

24. The computer-readable storage medium of claim 23, wherein the instructions configured to cause the apparatus to perform receiving the construction product type from the application being executed by the apparatus include being configured to perform receiving the construction product type from the application, the application being a construction project design application.
